(19) United States
(12) Patent Application Publication
(10) Pub. No.: US 2006/0210807 A1
(43) Pub. Date: Sep. 21, 2006

(54) Antifouling coating composition

(75) Inventor: Shawn D. Miller, Morrisville, NC (US)

Correspondence Address: MYERS BIGEL SIBLEY & SAJOVEC, PO BOX 37428, RALEIGH, NC, 27627, US

(73) Assignee: Microphase Coatings, Inc.

(21) Appl. No.: 11/370,683

(22) Filed: Mar. 8, 2006

Related U.S. Application Data
(60) Provisional application No. 60/660,812, filed on Mar. 11, 2005.

(51) Int. Cl. B32B 27/26; C08L 75/00; C08L 77/00; C08L 83/00; C08G 18/00

(52) U.S. Cl. 428/423.1; 428/447; 525/452; 525/540; 525/474

(57) ABSTRACT

The antifouling composition of the present invention includes a polyurea component formed from an aliphatic polyisocyanate and an amino-terminated silane, which is reacted with a polyamide curing agent blocked with an epoxy-modified silane.

### CROSS-REFERENCE TO RELATED APPLICATIONS

This application claims the benefit of, and incorporates herein by reference in its entirety, the following: U.S. Provisional Application No. 60/660,812, filed on Mar. 11, 2005.

### FIELD OF THE INVENTION

The present invention relates to an antifouling coating composition.

### BACKGROUND OF THE INVENTION

Fouling refers to the accumulation of airborne or water borne biological materials on the surface such as barnacles, seaweeds, tubeworms or other marine organisms. The hulls of ocean-going vessels and other underwater structures are particularly vulnerable to fouling because the biological materials are easily attracted to the under-water surface. The accumulation of fouling on those infrastructures and vessels can cause serious problems, for example, the extra fuel consumption resulting from the increased weight on drag, hull cleaning, repainting and the upkeep on propulsion equipment. The marine industry has to spend billions of dollars to overcome those problems every year.

A common approach to overcome the fouling problems is to apply antifouling coatings on the hull of vessels. Antifouling coatings usually contain toxicants, such as tributyltin compounds or copper oxide, which are released into water to keep biological materials from attaching to the hull of vessels. Several environmental concerns however, arise from the use of toxic antifouling coatings. One major concern is the severe disruption of the marine environment limiting the growth of a wide variety of marine life. Another environmental hazard is imposed by the removal and disposal of such toxicant-containing coatings from ships and other structures.

An alternative approach to toxicant antifouling coatings is to use antifouling agents containing acrylic acid monomer compositions (e.g., a polyester resin with an acrylic acid group) and a biocide. However, there are also several drawbacks to this type of coating. First, the biocide contained in the coating can become inactive after a period of time. Additionally, due to its water solubility, the coating composition brings fresh and active biocide at the water surface and wears off over time. In order to address those concerns, an improved approach is to use a polymeric coating such as poly(dimethylsiloxane) (“PDMS”). However, some studies showed that PDMS becomes unstable after the coating is immersed in water for three months.

Silicon rubber or silane-related antifouling agents have also been developed to replace the toxicant antifouling agents. One approach involves a composition primarily containing a reaction-curable silicone resin, which has a specific molecular weight and viscosity and an alkoxy group at the end of the molecule. The coating however, requires frequent reapplications because the silicone component easily wears off. Another approach was described in U.S. Pat. No. 6,413,446 B1 to Mechtel et al. The antifouling agents proposed comprise at least one multifunctional carbosilane, carbosiloxane and/or a partial condensation product thereof. Another approach was described in U.S. Pat. No. 6,476,095B2 to Simendinger. The proposed antifouling composition comprises a glassy matrix formed by crosslinking a mixture of a silanol-terminated silicone and an alkoxy-functionalized siloxane to provide an interpenetrating polymer network of glass and silicone and at least two materials capable of microphase separation, at least one of which is graftable to the glassy matrix.

Yet another alternative is to use a curable polyurethane to improve antifouling agents. For example, U.S. Pat. No. 6,313,335 B1 to Robberts et al., proposes certain hydrolyzable and/or hydrolyzed silyl-terminated fluorine containing polyurethanes, silicone containing polyurethanes and fluorine/silicone containing polyurethanes in aqueous dispersion can be used as a coating to inhibit the attachment of or facilitate the removal of marine organisms from the surface.

### SUMMARY OF THE INVENTION

The antifouling composition of the present invention comprises a polyurea component formed from an aliphatic polyisocyanate and an amino-terminated silane, which is reacted with a polyamide curing agent blocked with an epoxy-modified silane.

### BRIEF DESCRIPTION OF THE DRAWINGS

FIG. 1 is an example of a reaction used to form a polyurea component.

FIG. 2 is an example of a reaction used to form a polyamide curing agent blocked with an epoxy-modified silane.

FIG. 3 is an example of the reaction of the polyurea component and the polyamide curing agent.

### DETAILED DESCRIPTION OF THE INVENTION

The present invention relates to an antifouling composition comprising a polyurea component reacted with a polyamide curing agent. The polyurea component is formed from an aliphatic isocyanate and an amino-terminated silane. The polyamide curing agent is blocked with an epoxy-modified silane.

Suitable polyisocyanates include, but are not limited to, 1,4-tetramethylene diisocyanate, 1,6-hexamethylene diisocyanate, 2,2,4-trimethyl-1,6-diisocyanatohexane, 1,10-decamethylene diisocyanate, 1,4-cyclohexane diisocyanate, bis (4-isocyanatocyclohexyl) methane, 1-isocyanato-3-isocyanatomethyl-3,5,5,-trimethylcyclohexane, m- and p-phenylene diisocyanate, 2,6- and 2,4-tolyene diisocyanate, xylene diisocyanate, 4-chloro-1,3-phenylene diisocyanate, 4,4′-bisphenylene diisocyanate, 4,4′-methylene diphenylisocyante, 1,5-naphthylene diisocyanate, 1,5-tetrahydronaphthylene diisocyanate, 1,12-dodecyldiisocyanate, norbornate diisocyanate, 2-methyl-1,5-pentane diisocyanate and mixtures thereof.

Suitable amino-terminated silanes include, but are not limited to, 3-aminopropyltriethoxy silane, 3-aminopropyldimethylethoxy silane, 3-amiopropylmethyldiethoxy silane and 3-aminopropyltrimethoxy silane.

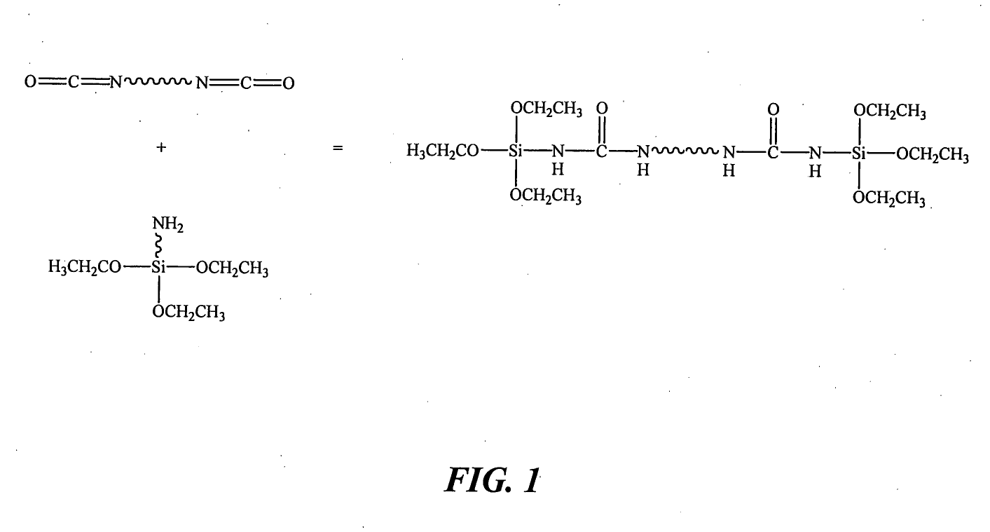

An exemplary reaction to form the polyurea is shown in FIG. 1. As shown, the amino-terminated silane reacts or couples with the isocyanate NCO groups and effectively endcaps the polymer thereby forming a polyurea with ethoxy group ligands. In one embodiment, the polyisocyanate is 1,6-hexamethylene isocyanate and the amino-functionalized silane is 3-aminopropyltriethoxysilane.

The polyamide curing agent is a fatty acid dimer such as Ancamide 220, a G-18 fatty acid dimer, available from Air Products, Allentown, Pa. The polyamide curing agent is blocked with an epoxy-modified silane such as glycidyl modified silane such as 3-(glycidoxypropyl)trimethoxysilane, 3-(glycidoxypropyl)-dimethylethoxysilane and 3-(glycidoxypropyl)methyldimethoxysilane. Benzyl alcohol or propanol can also be used to help compatabilize the amide curing agent and the silane.

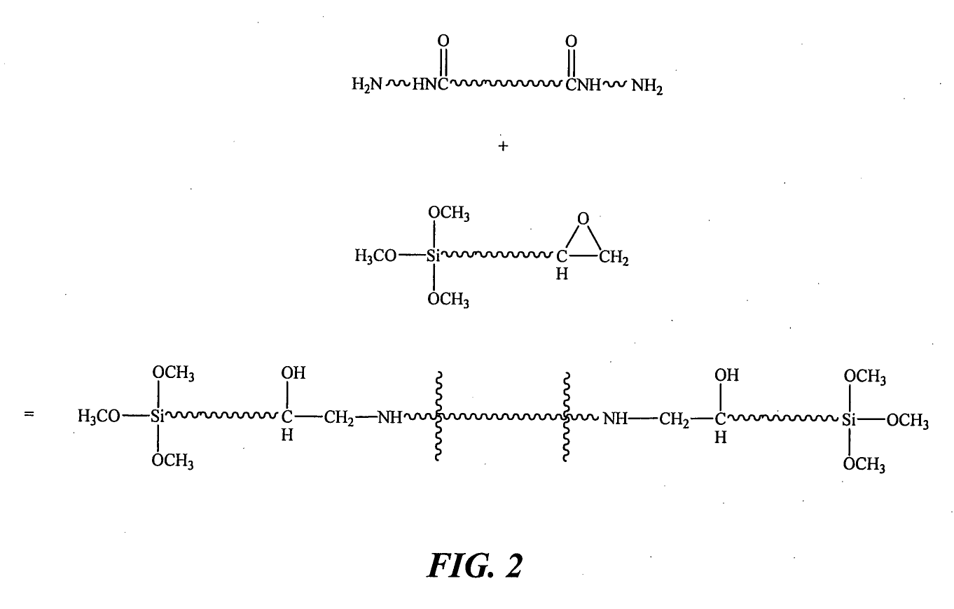

An exemplary reaction to form the polyamide curing agent blocked with an epoxy-modified agent is shown in FIG. 2. Heat may be used to catalyze the reaction so the epoxy groups and amine groups bind forming an endcapped polymer with methoxy group ligands.

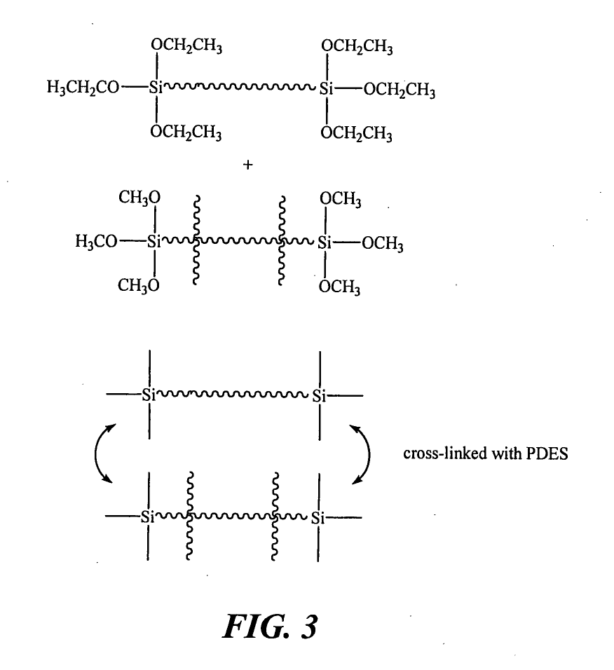

The reaction of the polyurea and the polyamide curing agent is shown in FIG. 3. Typically, the polyurea component and the polyamide curing agent are crosslinked with a polysiloxane such as polydiethoxysiloxane (“PDES”) and optionally a silane such as 3-amino propyltriethoxysilane. The reaction rate can be increased by using a catalyst such as titanium 2-ethylhexoxide.

The antifouling composition can optionally include a foul release agent. A particularly preferred foul release agent is an alkylhydrosiloxane polymer with a C₁ to C₂₀ alkene grafted thereto. An exemplary alkylhydrosiloxane is poly(methyl-hydrosiloxane) and an exemplary alkene is 1-octene. Such a foul release agent can be made by a hydrosilylation reaction using a platinum catalyst in a silicone oil solution. The poly(methylhydrosiloxane) is titrated into the octane mixture. This reacts the octane with the hydroxyl groups thereby endcapping the silicone at one end leaving the other end with reaction sites.

Optionally the mixture/antifouling composition can include an agent capable of preventing or inhibiting slime (e.g., algae, bacteria, protozoa, diatoms, etc.) from growing on the surface of the coating. While in most cases, such agent will be included in the composition, there are instances when slime is not an issue, and the anti-slime agent can be omitted. Suitable agents capable of preventing or inhibiting slime include surfactants, emulsifiers, enzymes, silver compounds, quaternary amine compounds, sulfa-based antimicrobial compounds, saponin and cholesterol, and mixtures and blends thereof.

The antifouling composition may also include fillers (e.g., fumed silica, mica, kaolin, bentonite, talc), zinc oxides, zinc phosphates, iron oxides, cellulose, pigments, corrosion inhibitors, UV light stabilizers, thixotropic agents, epoxy modifiers, polytetrafluoroethylene powder, ultra high molecular weight polyethylene powder, high, medium and low molecular weight polyethylene powder, or other additives, as will be readily apparent to those skilled in the art.

In general, the antifouling composition can comprise:

10 to 35 percent by weight polyisocyanate

1 to 15 percent by weight amino-terminated silane

30 to 65 percent by weight polyamide curing agent

10 to 25 percent by weight epoxy-modified silane

0 to 40 percent by weight foul release agent.

In operation, the antifouling composition of the present invention can be applied to various substrates by roll-coating, brush, spray coating, dipping and the like. The composition is preferably applied at a thickness of about 0.25 mm to 1.0 mm. Particularly, the antifouling composition can be applied on underwater surfaces and substrates such as ships, port facilities, buoys, pipelines, bridges, submarine stations, submarine oil field excavation facilities, water conduit raceway tubes in power plants, cultivating fishing nets, stationary fishing nets, and the like.

### EXAMPLE

A. Polyurea Component

35% Desmodur N 3200 (Bayer Chemical) or Tolonate HDB-LV (Rhodia) Chemical: 1,6-hexamethylene Diisocyanate (aliphatic polyisocyanate)

65% 3-Aminopropyltriethoxysilane (Gelest) (amino-terminated silane)

Throughly mix the diisocyanate and silane together until the material begins to exotherm. Continue to mix approximately every 5 minutes until the reaction begins to cool.

B. Polyamide Curing Agent

36% Ancamide 220 Polyamide Curing Agent (Air Products) (C-18 unsaturated fatty acid)

14% (3-Glycidoxypropyl)trimethoxysilane (Gelest) (epoxy-modified agent)

50% 2-propanol (Aldrich)

Mix the Ancamide 220 and the 3-glycidoxypropyltrimethoxysilane together. Place closed container into oven at 120° C. for 2 hours. Immediately add the 2-propanol to the mixture after removal from the oven. Final product forms a low viscosity orange liquid.

To form the antifouling composition, mix:

45.45% of A

40.91% of B

10.00% polydiethoxysiloxane
3.64% 3-aminopropyltriethoxysilane in a container. Add titanium 2-ethyl-hexoxide to speed up the cure.

C. Optional Foul Release Component

64.82% 1-octene (Aldrich)

34.66% poly(methylhydrosiloxane) (Gelest)
0.52% 5% platinum catalyst in a silicone oil solution

Mix 1-octene and platinum catalyst solution together in reaction vessel. Slowly add the poly(methylhydrosiloxane) to the mixture. This addition generates an aggressive exotherm. You must either use a water-jacketed mixing vessel or slowly add the material while measuring the temperature to keep it below 225° F. Final product resembles a low viscosity silicone.

To form an antifouling composition the foul release component including the following formulation is used:

26.64% of A

44.35% of B
5.39% polydiethoxysiloxane
1.97% 3-aminopropyltriethoxysilane

19.11% of C
4.45% titanium 2-ethylhexoxide
   All six components are sealed in a container to form a stable one-part solution.

In the specification and example, there have been disclosed typical preferred embodiments of the invention and, although specific terms are employed, they are used in a generic and descriptive sense only and not for purposes of limitation of the scope of the invention set forth in the following claims.

That which is claimed is:

1. An antifouling coating composition comprising:
(a) a polyurea component comprising a polyisocyanate and an amino-terminated silane; and
(b) a polyamide curing agent blocked with an epoxy-modified silane.

2. The antifouling coating composition according to claim 1, wherein the polyisocyanate is selected from the group consisting of 1,4-tetramethylene diisocyanate, 1,6-hexamethylene diisocyanate, 2,2,4-trimethyl-1,6-diisocyanatohexane, 1,10-decamethylene diisocyanate, 1,4-cyclohexane diisocyanate, bis (4-isocyanatocyclohexyl) methane, 1-isocyanato-3-isocyanatomethyl-3,5,5,-trimethylcyclohexane, m- and p-phenylene diisocyanate, 2,6- and 2,4-tolyene diisocyanate, xylene diisocyanate, 4-chloro-1,3-phenylene diisocyanate, 4,4′-bisphenylene diisocyanate, 4,4′-methylene diphenylisocyante, 1,5-naphthylene diisocyanate, 1,5-tetrahydronaphthylene diisocyanate, 1,12-dodecyldiisocyanate, norbornate diisocyanate, 2-methyl-1,5-pentane diisocyanate and mixtures thereof.

3. The antifouling coating composition according to claim 1, wherein the amion-terminated silane is selected from the group consisting of 3-aminopropyltriethoxy silane, 3-aminopropyldimethylethoxy silane, 3-amiopropylmethyldiethoxy silane and 3-aminopropyltrimethoxy silane.

4. The antifouling coating composition according to claim 1, wherein the polyamide curing agent is a fatty acid dimer blocked with a glycidyl-modified silane.

5. The antifouling coating composition according to claim 1, further comprising an antifouling agent.

6. The antifouling coating composition according to claim 5, further comprising a filler.

7. A substrate coated with the antifouling composition of claim 1.

8. An antifouling coating composition comprising:
(a) a polyurea component comprising a polyisocyanate and an amino-terminated silane;
(b) a polyamide curing agent blocked with an epoxy-modified silane; and
(c) a foul release component comprising an alkylhydrosiloxane polymer and a C₁ to C₂₀ alkene grafted thereto.

9. The antifouling coating composition according to claim 8, wherein the polyisocyanate is selected from the group consisting of 1,4-tetramethylene diisocyanate, 1,6-hexamethylene diisocyanate, 2,2,4-trimethyl-1,6-diisocyanatohexane, 1,10-decamethylene diisocyanate, 1,4-cyclohexane diisocyanate, bis (4-isocyanatocyclohexyl) methane, 1-isocyanato-3-isocyanatomethyl-3,5,5,-trimethylcyclohexane, m- and p-phenylene diisocyanate, 2,6- and 2,4-tolyene diisocyanate, xylene diisocyanate, 4-chloro-1,3-phenylene diisocyanate, 4,4′-bisphenylene diisocyanate, 4,4′-methylene diphenylisocyante, 1,5-naphthylene diisocyanate, 1,5-tetrahydronaphthylene diisocyanate, 1,12-dodecyldiisocyanate, norbornate diisocyanate, 2-methyl-1,5-pentane diisocyanate and mixtures thereof.

10. The antifouling coating composition according to claim 8, wherein the amion-terminated silane is selected from the group consisting of 3-aminopropyltriethoxy silane, 3-aminopropyldimethylethoxy silane, 3-amiopropylmethyldiethoxy silane and 3-aminopropyltrimethoxy silane.

11. The antifouling coating composition according to claim 8, wherein the polyamide curing agent is a fatty acid dimer blocked with a glycidyl-modified silane.

12. The antifouling coating composition according to claim 9, further comprising a filler.

13. A substrate coated with the antifouling composition of claim 8.
